(19) United States
(12) Patent Application Publication
(10) Pub. No.: US 2003/0118325 A1
(43) Pub. Date: Jun. 26, 2003

(54) Clean soundtrack for a DVD movie

(76) Inventor: Edward M. Schrader, Tucson, AZ (US)

Correspondence Address: Edward M. Schrader, 5738 E. Hawthorne St., Tucson, AZ, 85711, US

(21) Appl. No.: 10/035,891

(22) Filed: Dec. 24, 2001

(51) Int. Cl. H04N 5/91

(52) U.S. Cl. 386/94

(57) ABSTRACT

Disclosed is a DVD movie disk that includes a number of different, user-selectable soundtracks. On the disk, major portions of two of the soundtracks are identical except for a relatively small number of deleted or replaced words. The deleted and/or replaced words are words that may be considered objectionable to some people and may affect the movie's rating.

An alternate embodiment of the invention is in the form of computer software. When a DVD movie is inserted into a computer's DVD drive, the user can actuate the software to filter the soundtrack. This is accomplished by the software comparing each word in the soundtrack to a predetermined list of words. When a word on the soundtrack matches a word on the list, the word is altered or deleted prior to the soundtrack being played over a connected speaker.

### FIELD OF THE INVENTION

The invention is in the field of motion picture technology. More particularly, the primary embodiment of the invention is a DVD (Digital Versatile Disk) movie disk that includes a number of different, user-selectable soundtracks, including a “clean” soundtrack. The clean soundtrack is identical to a parent soundtrack on the movie disk, except that it does not include one or more words that may be considered objectionable to some people. The deleted and/or replaced words, when included in a soundtrack, often affect the movie's rating. Since both the parent and clean soundtracks are made available as selectable menu items, a user is provided with the ability to effectively choose the verbal content, and sometimes the rating, of the movie to be displayed.

An alternate embodiment of the invention is in the form of computer software. When a DVD movie disk is inserted into a computer's DVD drive, the user can actuate the software to filter-out certain words from the soundtrack. The software functions by first recognizing the soundtrack's words, and then comparing the words to a predetermined list of words. When a word on the soundtrack matches a word on the list, the word is altered or deleted prior to the soundtrack being played over the connected speaker.

### BACKGROUND OF THE INVENTION

The majority of movies available today are rated in order to provide an indication of the appropriateness of the movie for a particular viewing audience. When a movie is assigned a ‘G’ rating, it implies that the movie is appropriate for general audiences and does not include any sexual or language content that would be objectionable to viewers of any age. A ‘PG’ rating means that parental guidance is suggested and that the movie contains some material that may not be appropriate for some young viewers. As the movie content becomes more adult oriented, ratings progress from ‘PG-13’ to ‘R’, and then finally to ‘NC17’.

A common belief is that a movie that has a ‘G’ rating will not draw adolescent or older viewers since said viewers will think that a movie having a ‘G’ rating is made solely for small children. Many people believe that some movies include certain somewhat objectionable words just so that the movie will receive a non-‘G’ rating. However, some people prefer to watch, or give as gifts, movies that do not have any objectionable language. Therefore, for these language-discriminating individuals, their movie choices are extremely limited, often to only the movies made for small children.

If the language-discriminating person is willing to wait a long time to see a particular movie, he or she can watch an edited version of the movie when it is shown on television by a television network. However, when a movie is edited for television, the editing process will often remove non-objectionable portions of the movie to shorten its running time and allow for the insertion of numerous commercials. By removing non-objectionable portions of the movie and by breaking up the flow of the movie with the insertion of commercials, the television network will sometimes cause a less than satisfactory viewing experience for the language-discriminating viewer.

It is known in the movie industry to edit a movie having an ‘NC-17’ rating so that the movie will have an ‘R’-rating and can thereby be shown in more theaters. This process is not employed to lower a movie's rating sufficiently to a point where some language-discriminating persons would wish to watch the movie. Furthermore, this process is not employed to provide a movie that could be watched in either an altered or unaltered state.

There are a number of language-discriminating people who would desire to see certain movies, if only the movie soundtrack did not include one or more objectionable words. For these potential viewers, there are currently no available options that would allow them to see said movies.

### SUMMARY OF THE INVENTION

With the advent of the Digital Versatile Disk (DVD), a person can now play a movie recorded on a DVD movie disk using a DVD player and choose the language of the soundtrack played with the movie. This is made possible by the DVD movie disk having a number of different stored soundtracks. When a user is about to begin watching the movie, the DVD player can display a menu on the screen of the TV/monitor that allows a user to pick the language soundtrack that will play with the movie. Usually, a DVD movie disk will offer soundtracks in at least two different languages, such as English and French. In some cases, eight or more language choices may be offered.

The primary embodiment of the invention is a prerecorded DVD movie disk that includes a number of selectable soundtracks, including two soundtracks in the same language. The two same-language soundtracks consist of a parent soundtrack, and a “clean” soundtrack that is a derivative of the parent. A major portion of the words of both the parent and clean soundtracks are identical to each other. The two soundtracks differ in that a minor portion of the parent soundtrack's words are not included in the clean soundtrack. The missing words are words that some people may find objectionable and will often affect the movie's rating, i.e.—make a ‘G’-rated movie into a ‘PG’-rated movie.

The clean soundtrack will preferably be created after the movie has been made. While it would most likely be made by the studio/entity that made the movie, it is possible that the soundtrack could be produced by other companies/organizations that specialize in such an activity. To make the clean soundtrack, certain objectionable words in the parent soundtrack are either deleted, changed or replaced. This is preferably done in a manner that does not degrade the content or character of the original soundtrack. Preferably the clean soundtrack is a digitally re-mastered version of the original soundtrack, and uses the original actors to provide replacement words.

Once the clean soundtrack has been made, it is stored on a DVD movie disk along with the parent soundtrack. A user can then choose to watch the movie and listen to either an original or a clean soundtrack.

In an alternate embodiment of the invention, the invention is in the form of filtering software capable of “cleaning-up” the soundtrack of a movie as it is being shown by a display device. The software would preferably be used in a computer. A computer is hereby defined as any device that has the ability to rapidly process large amounts of information in a manner capable of filtering a soundtrack, as described herein.

In operation, when a viewer is ready to see a particular movie that is accessible by the computer, the user actuates the filtering software. The software will enable the computer to begin processing the movie information as it is accessed from a storage location, such as a DVD movie disk located in the computer's DVD drive, or the computer's hard-drive or some other computer-associated memory device. The movie's soundtrack is then filtered through the filtering software.

The filtering process is a three-step operation. Firstly, the computer accesses at least a portion of the soundtrack from the memory storage area and the words in the soundtrack are individually recognized. The word recognition process is very similar to that used by conventional voice recognition software. The second step involves the software checking each word in the soundtrack, or portion of the soundtrack, against a predetermined list of words that is preferably stored in the computer's memory and is associated with said software. The words on the list are those that may be objectionable to a language-discriminating listener. This process is very similar to that used when a computer checks a downloaded program for a virus, or prevents a user from accessing an internet pornography website. As a third step, whenever the software matches a particular word in the soundtrack to a word on the list, the software then either deletes or alters said word in the soundtrack. Once the software has completed the three steps of the filtering process, the filtered soundtrack, or portion of the soundtrack, is then played in combination with the video portion of the movie.

In either embodiment of the invention, a user is provided with the ability to view a prerecorded movie without certain words that the viewer may consider objectionable. This may oftentimes provide the user with the ability to alter the rating of the movie that will be presented on the display device.

### BRIEF DESCRIPTION OF THE DRAWINGS

FIG. 1 is a face or top view of a DVD movie disk in accordance with the invention. A small portion of the disk is shown in an extremely magnified condition.

FIG. 2 is a block diagram wherein the disk shown in FIG. 1 is being played by a DVD player device. The player device is shown displaying a menu screen on a viewing device.

FIG. 3 is a combination block and flow diagram of an alternate embodiment of the invention.

### DETAILED DESCRIPTION OF THE DRAWINGS

Referring now to the drawings in greater detail, wherein like reference numbers refer to like parts throughout the several figures, there is shown by the numeral 1 a DVD (Digital Versatile Disk or Digital Video Disk) movie disk in accordance with the invention.

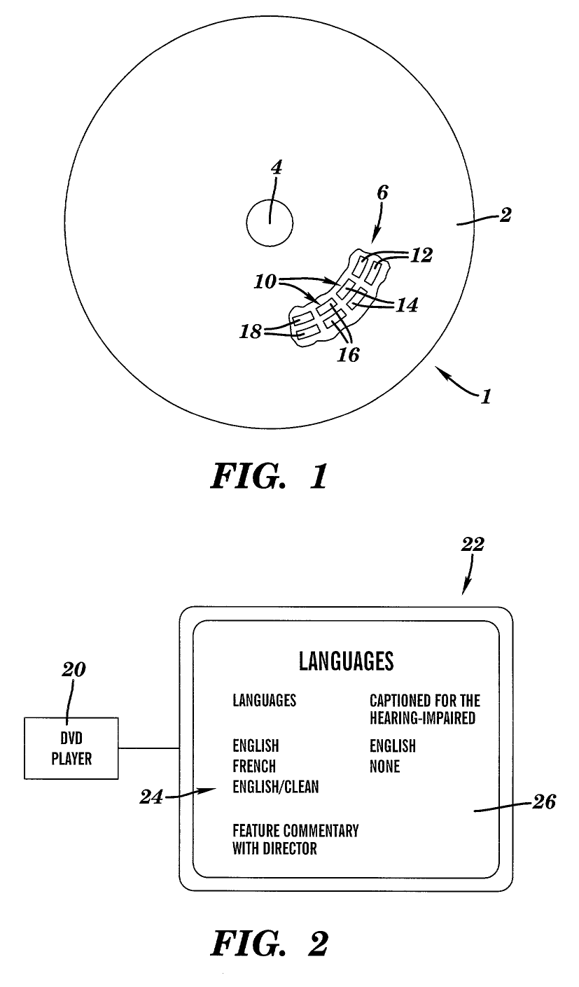

As can be seen in FIG. 1, the DVD movie disk 1 has a planar front face 2 and a central thru-hole 4. The front face overlies at least one information storage layer. In FIG. 1, the area designated as 6 provides a highly-magnified view of an extremely small portion of the storage layer. As can be seen, the storage layer consists of a planar surface 8 upon which are located a large number of raised, box-shaped bumps 10. The bumps are oriented whereby they, and the flat areas between them, form a spiral track. The use of a spiral track of flat areas and bumps is a conventional method for storing information on a DVD movie disk. Typically, the bumps are approximately 320 nanometers wide, a minimum of 400 nanometers long and approximately 120 nanometers high. Shown are two adjacent portions of the information track, with each portion having four bumps. These portions would normally be separated by a distance of only approximately 740 nanometers. On a typical DVD movie disk, the track will have a total length, if stretched out in a straight line, of almost seven and one-half miles.

When a DVD player reads the disk, a laser in the player follows the track and recognizes/translates the changing surface as an input of digital information. When a movie is stored on the disk, all of the movie information, including the video portion and all of the soundtracks, is recorded in the previously-described spiral pattern of bumps on a flat, planar surface.

In the magnified area 6 of FIG. 1, some of the bumps have been labeled as 12, 14, 16 and 18. Bumps 12 form a portion of the video portion of the movie. Bumps 14 form a portion of a first soundtrack. For this example, the first soundtrack is considered to be in the English language. Bumps 16 form a portion of a second soundtrack. For this example, the second soundtrack is considered to be in the French language.

As noted previously, most conventional movies, when available on a DVD movie disk, allow a user to listen to the original soundtrack or a different soundtrack that is in another language. In this example, the original soundtrack is in English and all of the bumps 14 on the disk form the complete English soundtrack. The other soundtrack formed using the bumps 16 on the disk is a full French translation of the words in the English soundtrack. It should be noted that when alternate language soundtracks are provided on a DVD movie Disk, a major portion of the original soundtrack's words, greater than fifty percent, is modified/translated to obtain the alternate foreign language soundtrack.

The bumps 18 form a portion of a third soundtrack stored on the DVD movie disk 1. For this example, the third soundtrack is also in the English language, but is a cleaned-up version of the first soundtrack formed by the bumps 14. This is unlike the prior art, where each soundtrack is in a different language whereby a majority of the words of one soundtrack are changed to create an alternate soundtrack.

The clean soundtrack formed by the bumps 18 does not include a minor portion of the words of the parent soundtrack formed by the bumps 14. A major portion of the third soundtrack is identical to a major portion of the first soundtrack.

It should be noted that the clean soundtrack can be in any language, as long as it is in the same language as the parent soundtrack. It should also be noted that the parent soundtrack does not have to be a movie's original soundtrack. For example, the clean soundtrack can be in English and its parent soundtrack could be an English translation of an original soundtrack that is in French.

Since the clean soundtrack does not differ in its basic language from its parent soundtrack, it is not considered an alternate language soundtrack. Furthermore, unlike the alternate language soundtracks, playing the clean soundtrack in lieu of its parent soundtrack may effectively change the movie's rating.

To make the clean soundtrack, one starts with an original, parent soundtrack. One then decides which words in the parent soundtrack will be objectionable to certain language-discriminating viewers. The words that will usually be considered objectionable are often those words that would cause a movie to get a more restrictive rating, such as a ‘PG’-rating in lieu of a ‘G’-rating. The objectionable words are then deleted, altered or replaced.

For example, one may wish to delete the word “damn” from a movie. One could then delete that word wherever it appears in the soundtrack. One may instead alter the objectionable words. For example, whenever the word “damn” comes up in the soundtrack, one could delete a portion of the word, for example creating the word “amn.” Alternatively, and most preferred, one can replace each occurrence of “damn” with a word that some people would consider less offensive, such as “darn.” This would preferably be accomplished through a process whereby the original soundtrack is digitally re-mastered and the appropriate actor voices over/replaces each occurrence of “damn” with “dang.”

Once the parent soundtrack has been altered to create the clean soundtrack, the clean soundtrack is stored on the DVD movie disk along with all of the other soundtracks. The clean soundtrack is then made available as a specific menu item when the disk is to be played in a DVD player.

FIG. 2 shows a DVD player 20 connected to a conventional viewing device 22 such as a television or computer monitor. It should be noted that a DVD player is to be considered any device that is capable of playing a DVD movie disk, including conventional DVD players and also a DVD disk drive connected to, or forming a part of, a computer.

When the movie is initially inserted into the DVD player, a menu 24 is automatically, or via a user-actuable switch, brought up on the screen 26 of the viewing device. An example of such a menu is shown in FIG. 2. As can be seen in the drawing figure, the user is presented with a number of soundtracks (English, French and English/clean) that can be played in combination with the video portion of the movie. The English/clean soundtrack is a “clean” version of the parent soundtrack that, for this example, happens to be in English. While not shown, the menu can include a brief description of what is meant by a “clean” soundtrack. If desired, an associated rating for each of the soundtracks may also be included in the menu. For example, beside the English and French soundtrack listings could be the phrase, “PG-Rating,” while beside the English/clean listing could be the phrase, “no objectionable words, G-Rating.”

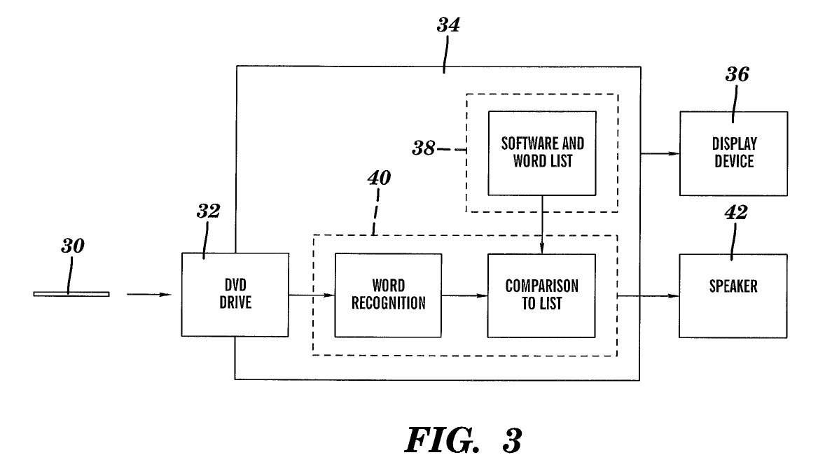

FIG. 3 shows, in a generalized block diagram that is also a flow chart, an alternate embodiment of the invention.

A conventional movie disk 30 that includes a stored movie but does not include a “clean” soundtrack, is inserted into the DVD drive 32 of a computer 34. As previously noted, the term computer is broadly defined and may include, in addition to a conventional computer, a DVD player or other device that features significant processing power and memory. Once the user actuates the computer to read from the DVD drive, a menu screen, basically identical to menu 24 shown in FIG. 2, is brought up on the display device 36. The display device may be either a computer monitor, a television or some other conventional display device connected to the computer.

The menu screen lists a number of user-selectable soundtrack choices that can be played in combination with the video portion of the movie. While the choice of a “clean” soundtrack is included in the data that was stored in the previously described DVD movie disk 1, the computer will preferably add the choice of a clean soundtrack when a conventional DVD disk 30 that does not have a clean soundtrack is employed.

If the user elects to see a “clean” version of the movie, the computer will then run the soundtrack-filtering software stored in its memory 38. The first step performed by the software occurs as the computer reads the soundtrack data from the disk. Each word in the soundtrack is analyzed by the computer's processor 40. The analysis is basically identical to the analysis that occurs when a computer runs conventional voice recognition software. Once the sounds of a word are determined, the software performs its next step.

Located in the computer's memory 38 is a list of words associated with the filtering software. The words in the list are words that a language-discriminating listener would find objectionable. The computer then attempts to match each word in the soundtrack against the list of words in memory.

When a word on the soundtrack matches a word on the list, the software will then perform its final step. It will either delete or change the word in the soundtrack. For example, any time the word “damn” is to be spoken in the movie, the filtering software will either delete the word, or alter it to a new word by deleting or changing one or more of the word's sounds. For example, the computer could change the word to “am.”

After the computer has checked the words in the soundtrack, and any objectionable word has been deleted or changed, the soundtrack is then played via the speaker 42 in a synchronous manner with the video portion of the movie. It should be noted that the soundtrack can be analyzed in its entirety prior to playing the movie, or in portions as the movie is being played.

The preferred embodiments of the invention disclosed herein have been discussed for the purpose of familiarizing the reader with the novel aspects of the invention. Although preferred embodiments of the invention have been shown and described, many changes, modifications and substitutions may be made by one having ordinary skill in the art without necessarily departing from the spirit and scope of the invention as described in the following claims.

I claim:

1. A DVD movie disk comprising:
a disk having a quantity of stored information on a portion thereof, wherein said stored information can be read by a DVD player device;
wherein a first portion of said stored information provides a first soundtrack of a movie in a first language whereby said first soundtrack comprises a plurality of words in said first language;
wherein a second portion of said stored information provides a second soundtrack of said movie that is also in said first language whereby said second soundtrack comprises a plurality of words in said first language, wherein a minor portion of said words of said first soundtrack is not included in said second soundtrack, and wherein said words that are not included in said second soundtrack are of a type that would normally not be found in a ‘G’-rated movie;
wherein a third portion of said stored information provides a visual portion of said movie; and
wherein when said DVD movie disk in played using a DVD player device, a user can select to view the movie with either of said first or second soundtracks.

2. The DVD movie disk of claim 1 wherein the second soundtrack is a digitally re-mastered version of the first soundtrack.

3. The DVD movie disk of claim 1 wherein the first soundtrack includes a particular word whereby when said first soundtrack is played with the visual portion of the movie, the inclusion of said particular word necessitates the movie receiving a predetermined rating that corresponds to a particular minimum maturity level, and wherein said second soundtrack does not include said particular word whereby when said second soundtrack is played with the visual portion of said movie, said movie would receive a rating that corresponds to a particular minimum maturity level that is different from that of the first soundtrack.

4. The DVD movie disk of claim 1 wherein a fourth portion of said stored information provides a third soundtrack of said movie, wherein said third soundtrack is in a second language whereby a plurality of words of said third soundtrack are in said second language and wherein a major portion of the words of said first soundtrack are not included in said third soundtrack.

5. A DVD movie disk comprising:
a disk having a movie stored thereon, wherein the movie is in the form of a quantity of stored information, and wherein said stored information can be read by a DVD player device;
wherein a first portion of said stored information provides a first soundtrack of a movie, wherein said first soundtrack is in a first language whereby said soundtrack includes a plurality of words, and wherein a major portion of said plurality of words is in said first language;
wherein a second portion of said stored information provides a second soundtrack of said movie, wherein said second soundtrack is in a second language whereby said second soundtrack includes a plurality of words, wherein a major portion of the words of said second soundtrack is in said second language, and wherein said second language is different from said first language;
wherein a third portion of said stored information provides a third soundtrack of said movie, wherein said third soundtrack is in said first language whereby said third soundtrack includes a plurality of words, wherein a major portion of said plurality of words is in said first language, wherein a minor portion of the words of said first soundtrack are not included in said third soundtrack, and wherein said minor portion of the first soundtrack's words that are not included in said third soundtrack is of a type that at least some people would consider objectionable;
wherein a fourth portion of said stored information provides a visual portion of said movie; and
wherein when said DVD movie disk in played using a DVD player device, a user can select to watch the movie with any one of said first, second or third soundtracks.

6. The movie disk of claim 5 wherein said first soundtrack and said third soundtrack are identical except for said words that are not included in said third soundtrack.

7. The movie disk of claim 5 wherein when said third soundtrack is created, a substitute word is used in place of at least one of said words from said first soundtrack that is not included in said third soundtrack.

8. The DVD movie disk of claim 5 wherein the third soundtrack is a digitally re-mastered version of the first soundtrack.

9. The DVD movie disk of claim 5 wherein the first soundtrack includes a particular word, wherein when the movie is viewed using said first soundtrack, the inclusion of said particular word causes the movie to receive a predetermined rating that corresponds to a particular minimum maturity level, and wherein said third soundtrack does not include said particular word, wherein when said movie is viewed using said third soundtrack, the movie would receive a rating that corresponds to a particular minimum maturity level that is different from that given the movie using the first soundtrack.

10. A method for presenting a movie wherein at least one predetermined word has been removed from a soundtrack of said movie, said method comprising:
having a computer read a quantity of data relating to said movie, wherein said data is located on a data storage device, wherein said data includes information relating to a visual portion of said movie and a soundtrack for said movie, wherein said soundtrack includes a plurality of words;
having said computer analyze at least a portion of said data associated with said soundtrack, whereby when said computer analyzes said data, it recognizes the individual words in said soundtrack;
wherein said computer then attempts to match each word of said soundtrack against a predetermined list of words; and
wherein if said computer finds a word in said soundtrack that is also included in said predetermined list of words, the computer will then modify said soundtrack to omit said word as said computer presents said movie via a display device and at least one speaker, whereby a user can then watch said movie and listen to the words in said soundtrack and not hear any words that are included in said predetermined list of words.

11. The method of claim 10 wherein when said computer finds a particular word in said soundtrack that is also included in said predetermined list of words, the computer will delete said particular word from said soundtrack and play no word in the place of the deleted word when presenting said soundtrack via a display device and at least one speaker.

12. The method of claim 10 wherein when said computer finds a particular word in said soundtrack that is also included in said predetermined list of words, the computer will play an altered word in lieu of said particular word when it presents said movie via a display device and at least one speaker.
